(19) United States
(12) Patent Application Publication
(10) Pub. No.: US 2009/0070439 A1
(43) Pub. Date: Mar. 12, 2009

(54) SYSTEM AND METHOD FOR GENERATING A PLUGGABLE NETWORK STACK INTERFACE

(76) Inventors: Hongfeng WEI, Anaheim, CA (US); Ajit Sodhi, Irvine, CA (US); Aksar Kanamkandy, Lake Forest, CA (US); Scott Dolim, Trabuco Canyon, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/852,001

(22) Filed: Sep. 7, 2007

(51) Int. Cl. G06F 15/16

(52) U.S. Cl. 709/220

(57) ABSTRACT

The subject application is directed to a system and method for generating a pluggable network stack interface. A plurality of common network communication features associated with each of a plurality of network stacks are first mapped via a network interface stack. A network stack associated with an installed network communication component is then sensed. Features associated with a sensed network communication component are then mapped in accordance with the mapping of the plurality of common network communication features. Network services are then commenced in accordance with the output of the mapping of features associated with a sensed network communication component. Thereafter, configuration file data corresponding to commenced network services is communicated to an associated data storage.

### BACKGROUND OF THE INVENTION

The subject application is directed generally to configuration of network services in networked devices. The subject application is particularly applicable to configuration of network services associated with document processing devices.

Conventional document processing services include printers, copiers, facsimile machines, and scanners. More recently, multifunction peripherals (MFPs) have evolved to perform more than one of these document processing function.

Due to the cost of purchasing and supporting document processing devices, most offices will share them among two or more users. More recently, document processing services are accessible to users via network connections, allowing users to initiate print, fax, scan, or copy operations from one or more networked computers. The many functions that may be supported by network operation, as well as the many different data communication protocols associated with networks, cause setup and configuration of network stacks of a device difficult to configure or maintain.

It is frequently incumbent upon developers to develop complex network interfaces to allow for implementation of desired network devices or services. This operation requires much development time, as well as time for testing and debugging. Additionally, use of multiple or varied network communication interfaces increases chances for conflicts or other incompatibilities. An errant entry is likely to disable network services that had been operating effectively prior to addition.

### SUMMARY OF THE INVENTION

In accordance with one embodiment of the subject application, there is provided a system and method for configuring network services in networked devices.

Further, in accordance with one embodiment of the subject application, there is provided a system and method for configuring network services associated with document processing devices.

Still further, in accordance with one embodiment of the subject application, there is provided a system for generating a pluggable network stack interface. The system comprises a network interface stack including data representative of a mapping of a plurality of common network communication features associated with each of a plurality of networks stacks. The system also comprises sensing means adapted for sensing a network stack associated with an installed network communication component and registration means adapted for mapping features associated with a sensed network communication component in accordance with content of the network interface stack. The system further comprises communication means adapted for commencing network services in accordance with an output of the registration means and means adapted for communicating configuration file data corresponding to commenced network services with an associated data storage.

In one embodiment of the subject application, the system also includes testing means adapted for testing operation of commenced network services and means adapted for selectively restarting network services in accordance with configuration file data retrieved from the data storage in accordance with an output of the testing means. Preferably, retrieved configuration file data is comprised of configuration file data associated with a last-known successfully commenced network services. Preferably, the configuration file is comprised of an XML data file.

In another embodiment of the subject application, the system further includes means adapted for altering the configuration file in accordance with an associated thin client interface.

In yet another embodiment of the subject application, the system also includes means adapted for receiving mapping data associated with mapping of at least one predefined network stack. In such embodiment, the registration means includes means adapted for registering a sensed communication component associated with the at least one predefined network stack corresponding thereto.

Still further, in accordance with one embodiment of the subject application, there is provided a method for generating a pluggable network stack interface in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a pluggable network stack interface system according to one embodiment of the subject application;

FIG. 2 is a block diagram illustrating controller hardware for use in the pluggable network stack interface system according to one embodiment of the subject application;

FIG. 3 is a functional diagram illustrating the controller for use in the pluggable network stack interface system according to one embodiment of the subject application;

FIG. 4 is a block diagram illustrating a pluggable network stack interface system according to one embodiment of the subject application;

FIG. 5 is a flowchart illustrating a method for generating a pluggable network stack interface according to one embodiment of the subject application; and

FIG. 6 is a flowchart illustrating a method for generating a pluggable network stack interface according to one embodiment of the subject application.

### DETAILED DESCRIPTION OF THE PREFERRED EMBODIMENT

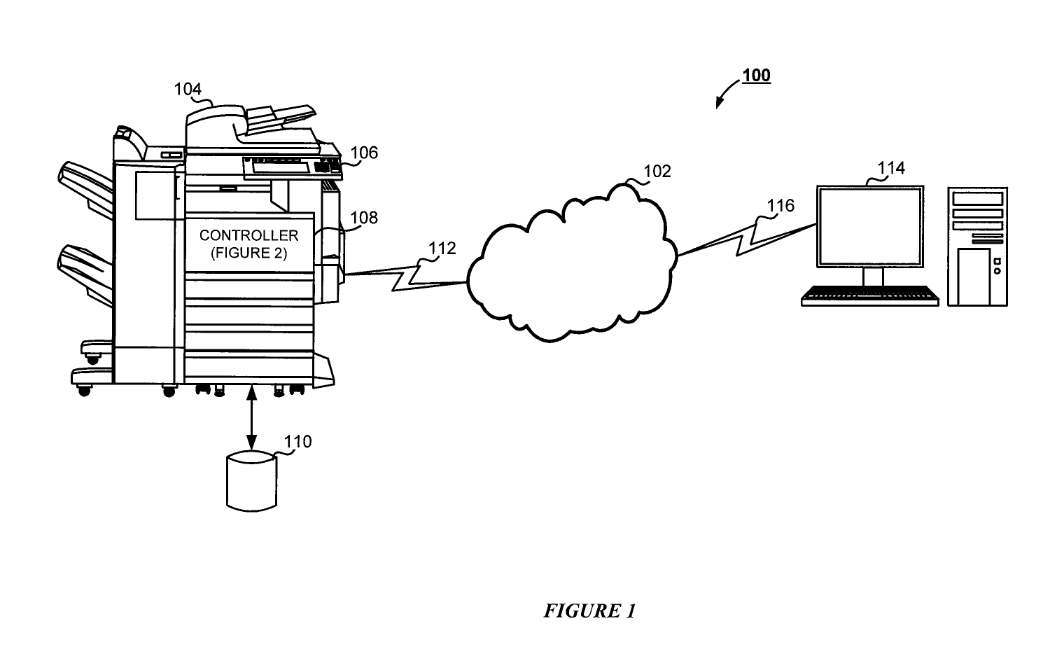

The subject application is directed to a system and method for configuring network services in networked devices. In particular, the subject application is directed to a system and method for configuring network services associated with document processing devices. More particularly, the subject application is directed to a system and method for generating a pluggable network stack interface. It will become apparent to those skilled in the art that the system and method described herein are suitably adapted to a plurality of varying electronic fields employing network communications, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for generating a pluggable network stack interface in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

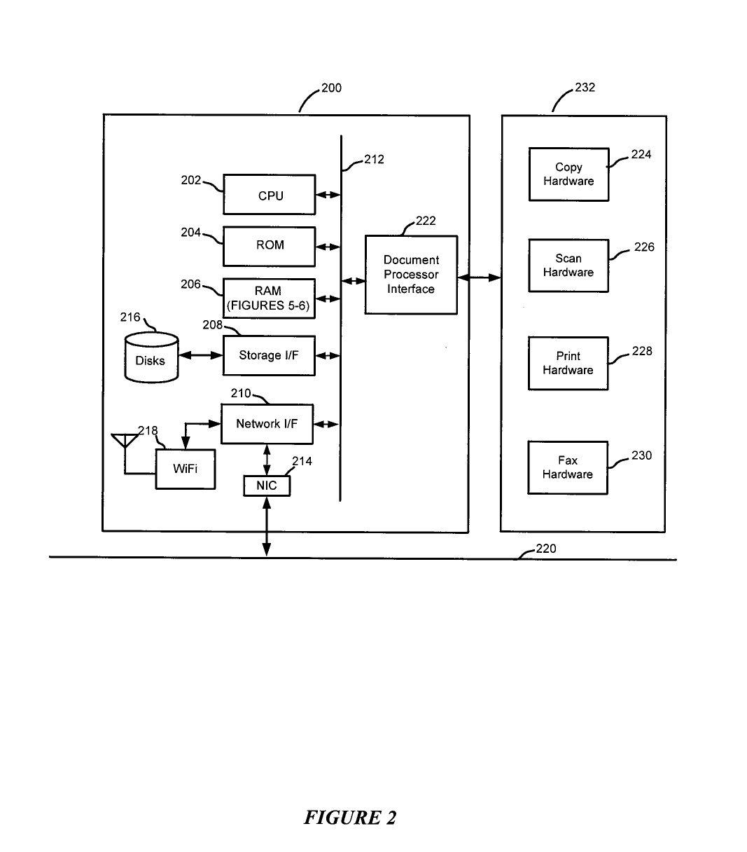

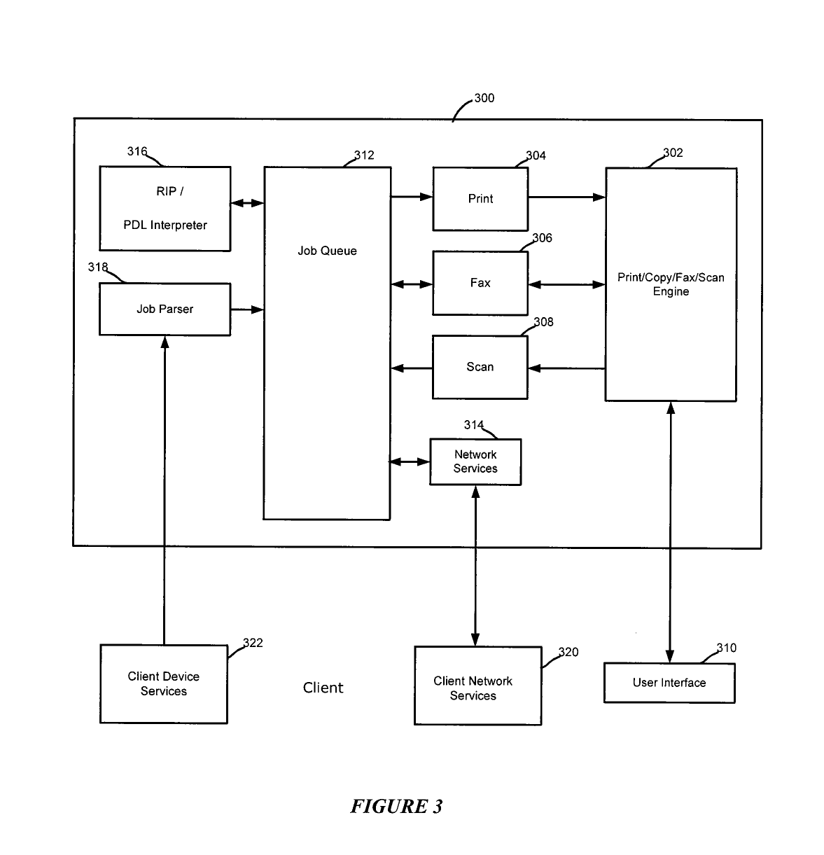

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for generating a pluggable network stack interface of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store configuration data, document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a computer workstation for illustration purposes only. As will be understood by those skilled in the art, the user device 114 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

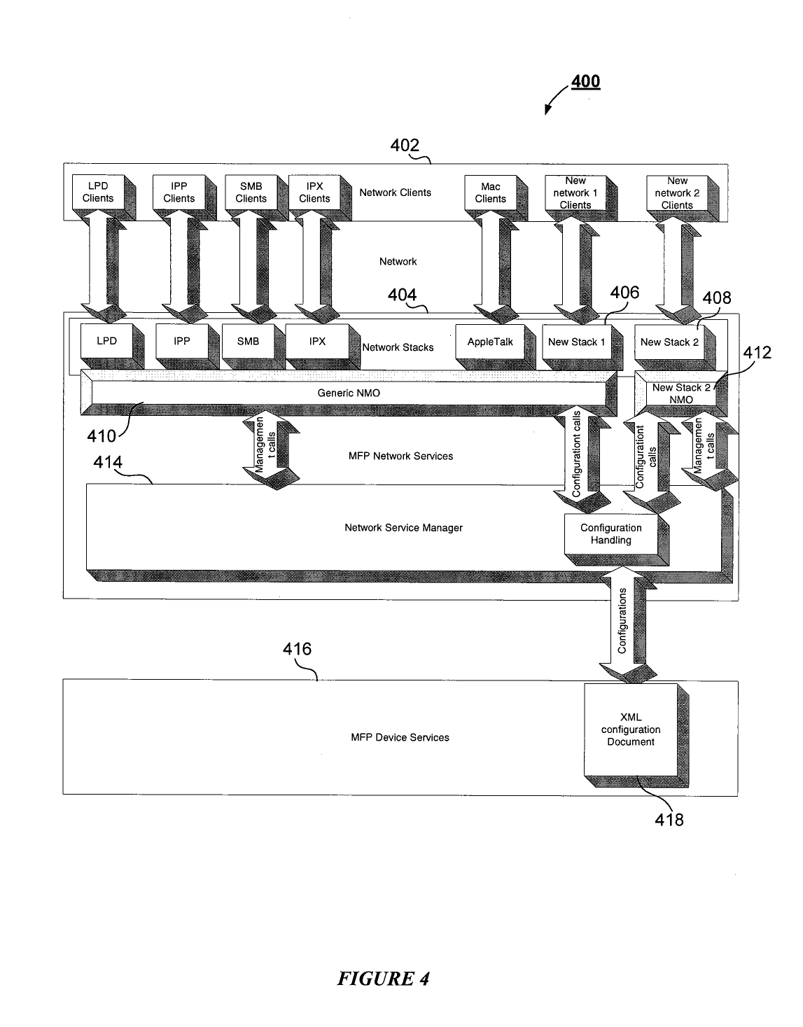

Turning now to FIG. 4, there is shown a block diagram 400 illustrating a pluggable network stack interface system in accordance with one embodiment of the subject application.

As shown in FIG. 4, the system 400 includes a plurality of network clients 402 representative of various clients communicating with the document processing device 104 of the subject application. The system 400 further includes a plurality of network stacks 404 representative of the network stacks employed for communications between the clients 402 and the document processing device 104. The network stacks 404, for purposes of example only, also includes at least one new stack 406 capable of using a generic network management object 410 and at least one new stack 408 employing a new network management object 412, which is addressed in greater detail below. In data communication with the network stacks 404, 406, and 408 are a generic network management object 410 and a new network management object 412. As will be appreciated by those skilled in the art, the network management objects 410 and 412 provided by network stacks 404, 406, and 408, are libraries that provide the implementation of pre-defined network service management and configuration interfaces. Preferably, the generic network management object 410 functions to provide base register, unregister, status monitoring, start and stop features, enabling and disabling features, simple configuration format mapping, and the like, to the document processing device 104. Communicatively coupled to the generic network management object 410 and the new network management object 412 is a network service manager 414, which uses network management objects 410 and 412 to manage and configure network components via pre-defined network service management and configuration interfaces. The document processing device services 416 includes an XML configuration file 418 for configuring the network stacks 404, 406, and 408, as is explained in greater detail below.

In operation, common network communication features associated with each of a plurality of network stacks are first mapped via a network interface stack. A network stack is then sensed in association with an installed network communication component. Features associated with the sensed component are then mapped in accordance with the mapping of the plurality of common network communication features. Network services are then commenced based upon the output of the mapping of the features associated with the sensed network communication component. Configuration file data is then communicated to an associated data storage corresponding to commenced network services.

In accordance with one example embodiment of the subject application, a network service manager component 414 is first initiated on the controller 108 associated with the document processing device 104. Preferably, the network service manager component 414 is any software, hardware, or suitable combination thereof, which uses network management objects to manage and configure network components via pre-defined network service management and configuration interfaces. Upon the receipt of a new network stack component 406 or 408, the controller 108, via operations of the network service manager 414, determines whether the component 406 or 408 corresponds to a predefined network stack. Mapping data associated with the mapping of the predefined network stack component is then received by the controller 108 when the network stack component 406 or 408 is a predefined network stack. When the network stack component 406 or 408 is not a predefined network stack, a determination is made whether the received data, inclusive of the new stack component 406 or 408, includes a network management object 412. That is, when the component 406 is received, no new network management object 412 is received, but when the component 408 is received, a new network management object 412 is also received. As will be understood by those skilled in the art, a network management object is a library provided by network stacks, which provide the implementation of pre-defined network service management and configuration interfaces. In accordance with one embodiment of the subject application, the controller 108 employs a generic network management object 410 that functions to provide base register, unregister, status monitoring, start and stop features, enabling and disabling features, simple configuration format mapping, and the like, to the document processing device 104.

When it is determined that a new network management object 412 was not included in the received network stack component, e.g., component 406, the new stack component 406 is associated with a generic network management object 410 in association with the network service manager 414 of the controller 108. When the received network stack component, e.g., component 408, includes a corresponding network management object 412, the new network management object 412 is added to the network management objects 410 and 412 available to the network service manager 414 operative on the controller 108.

Thereafter, common network communication features are mapped via the network interface stacks 404. That is, common network communication features are mapped using the network management object 410 or 412 associated with the new network stack component 406 or 408 by the network service manager 414. A network stack 404 associated with an installed network communication component is then sensed by the network service manager 412 of the controller 108. Any sensed communication components associated with a predefined network stack component are registered with the network service manager 414. Features associated with sensed components are then mapped to common network communication features. Thereafter, network services are commenced in accordance with the mapped features associated with the sensed network communication component. Configuration file data 418 corresponding to the commenced network services is then communicated to an associated data storage 110.

The network service manager 414 then tests the operation of the commenced network service so as to determine whether the service has been successfully initiated. When the service was unsuccessfully started, configuration file data 418 corresponding to a last known good configuration is retrieved from the associated data storage device 110. Network services are then selectively restarted according to the retrieved configuration file data 418. Once a service has been successfully initiated, normal operations of the document processing device 104 are commenced until alteration data is received. That is, the document processing device 104 performs normal operations until an administrator, via a thin client interface, communicates alteration data to the document processing device 104. Upon receipt of the alteration data, the configuration file data 418 is modified to incorporate the changes received from the administrator. Network services are then selectively restarted in accordance with the changes to the configuration file data 418 and upon successful restart, normal operations of the document processing device 104 are commenced.

For example, when the document processing device 104 receives a new network stack component, for example an AppleTalk network stack, the network service manager first determines whether this is a predefined network stack. When such is not the case, a determination is made whether a network management object associated with the AppleTalk network stack has been received. When no such object was received with the AppleTalk network stack, the network service manager associates the AppleTalk network stack with the generic network management object. Common network communication features associated with the AppleTalk network stack are then mapped via the network interface stack associated with the generic management object. Detected network stacks, e.g., the AppleTalk network stack, associated with installed network communication components are mapped to common network communication features. That is, the network service manager maps various communication features, common to a plurality of different network stacks, to the AppleTalk stack, thereby improving communications available to clients using the AppleTalk network stack for operations with the document processing device 104. The mapping is then stored in an XML configuration file on the data storage device 104. When needed, the network service manager initiates a system restart to initiate the installed service, e.g., AppleTalk. When problems are detected, an administrator is able to modify the configuration file, via a thin client interface on the user device 114, to correct the error. Alternatively, the network service manager is capable of retrieving the configuration file from the storage device 110 corresponding to the last known operable configuration (good configuration) and restarting the system in accordance with that retrieved configuration file.

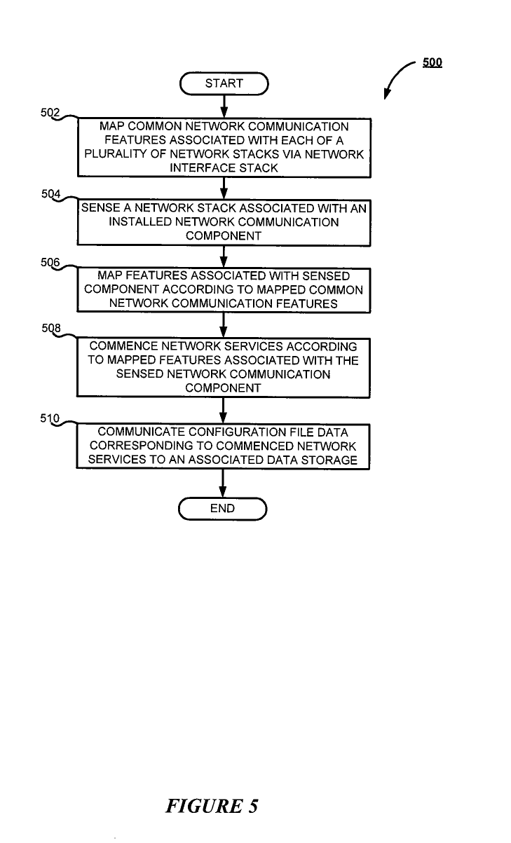

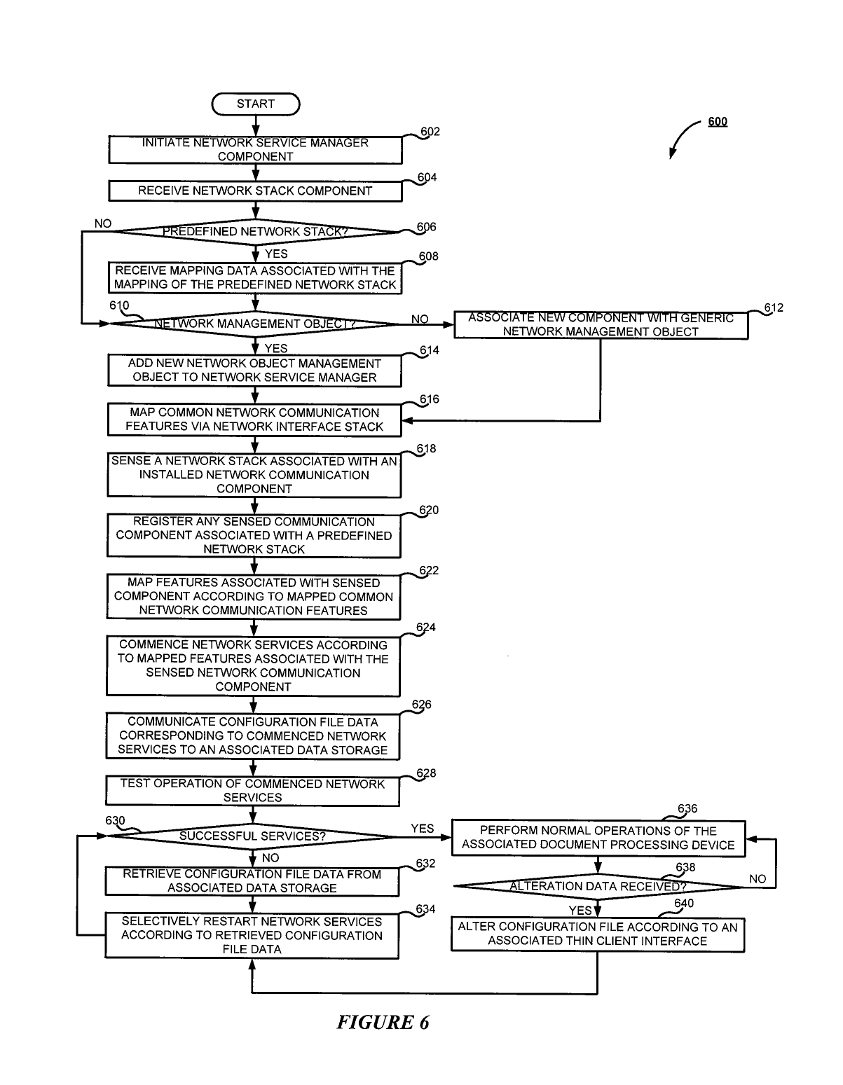

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for generating a pluggable network stack interface in accordance with one embodiment of the subject application. Beginning at step 502, common network communication features associated with each of a plurality of network stacks 404 are first mapped via a network interface stack. According to one embodiment of the subject application, a generic network management object 410, operative on the controller 108 associated with the document processing device 104, functions to provide base register, unregister, status monitoring, start and stop features, enabling and disabling features, simple configuration format mapping, and the like, to the document processing device 104. It will be appreciated by those skilled in the art that network management objects 410 and 412 are libraries provided by network stacks, which provide the implementation of pre-defined network service management and configuration interfaces. The skilled artisan will further appreciate that a network service manager component 414, resident on the controller 108 as software, hardware, or any suitable combination thereof, uses network management objects to manage and configure network components via the pre-defined network service management and configuration interfaces.

A network stack is then sensed at step 504 in association with an installed network communication component. Suitable examples of network stacks 404 include, without limitation, LPD, SMB, IPP, AppleTalk, IPX, and the like. At step 506, features associated with the sensed component are then mapped in accordance with the mapping of the plurality of common network communication features. Network services are then commenced at step 508 based upon the output of the mapping of the features associated with the sensed network communication component. At step 510, configuration file data 418 corresponding to commenced network services, is then communicated to an associated data storage. In accordance with one embodiment of the subject application, the configuration file data 418 is embodied in an extensible markup language (XML) document.

Referring now to FIG. 6, there is shown a flowchart 600 illustrating a method for generating a pluggable network stack interface in accordance with one embodiment of the subject application. The methodology of FIG. 6 begins at step 602, whereupon a network service manager component 414 is first initiated on the controller 108 associated with the document processing device 104. Preferably, the network service manager component 414 is any software, hardware, or suitable combination thereof, which uses network management objects to manage and configure network components via pre-defined network service management and configuration interfaces. At step 604, a new network stack component 406 or 408 is received by the controller 108 via operations of the network service manager 414. A determination is then made at step 606 whether the received network stack component 406 or 408 corresponds to a predefined network stack. When it is determined that the received component corresponds to a predefined network stack, flow proceeds to step 608, whereupon mapping data associated with the mapping of the predefined network stack component is received by the controller. Operations then proceed to step 610, discussed below.

Upon a determination at step 606 that the received component 406 or 408 does not correspond to a predefined network stack, flow progresses directly to step 610, whereupon a determination is made whether a network management object 410 or 412, was received in association with the received network stack component 406 or 408. As stated above, network management objects 410 and 412 correspond to libraries provided by network stacks, which provide implementations of predefined network service management and configuration interfaces. Preferably, the controller 108 employs a generic network management object 410 that functions to provide base register, unregister, status monitoring, start and stop features, enabling and disabling features, simple configuration format mapping, and the like, to the document processing device 104.

When it is determined at step 610 that a new network management object 412 was not included in the received network stack component, e.g., component 406, the new stack component 406 is associated with a generic network management object 410 in association with the network service manager 414 of the controller 108 at step 612. Operations then proceed to step 616, whereupon common network communication features are mapped via a suitable network interface stack. When the controller 108 determines at step 610, that the received network stack component includes a corresponding network management object, e.g., component 408 and associated object 412, flow proceeds to step 614, whereupon the new network management object 412 is added to the network management objects 410 and 412 available to the network service manager 414 operative on the controller 108. Thereafter, at step 616, common network communication features are mapped via the network interface stack. The skilled artisan will appreciate that common network communication features are thus mapped using the network management object 410 or 412 associated with the new network stack component 406 or 408, by the network service manager 414.

At step 618, a network stack associated with an installed network communication component is then sensed by the network service manager 414 of the controller 108. Flow then proceeds to step 620, whereupon any sensed communication components associated with a predefined network stack component are registered with the network service manager 414. The network service manager component 414 associated with the controller 108 then maps, at step 622, features associated with sensed components to common network communication features. The network service manager 414 associated with the controller 108 then commences network services at step 624 in accordance with the mapped features associated with the sensed network communication component. At step 626, configuration file data 418 corresponding to the commenced network services is then communicated to an associated data storage 110. In accordance with one embodiment of the subject application, the configuration file data 418 is an

XML configuration document. A suitable example of a corresponding XML document is shown below:

```
        <?xml version=“1.0” encoding=“UTF-8”?>
        <!--Sample XML file generated by XMLSPY v2004 rel. 4 U
        (http://www.xmlspy.com)-->
        <Network>
          <Services>
            <NetWare>
                <name>aa</name>
                <enabled>1</enabled>
                <active>1</active>
                <Dependencies>
                    <protocol>aa</protocol>
                    <protocol>aa</protocol>
                </Dependencies>
                <Environment>
                    <bindery>1</bindery>
                    <NDS>1</NDS>
                </Environment>
                <mode>NPRINTER</mode>
                <printerNumber>1</printerNumber>
                <context>normalizedString</context>
                <tree>normalizedString</tree>
          <advertizedName>normalizedString</advertizedName>
          <fileServerName>normalizedString</fileServerName>
          <printServerName>normalizedString</printServerName>
                <serverDiscovery>Auto</serverDiscovery>
                <loginName>String</loginName>
                <password>A9FD64E12C</password>
                <searchRoot>normalizedString</searchRoot>
                <queueScanRate>2</queueScanRate>
            </NetWare>
            <LPD>
                <name>aa</name>
                <enabled>1</enabled>
                <active>1</active>
                <Dependencies>
                    <protocol>aa</protocol>
                    <protocol>aa</protocol>
                </Dependencies>
                <portNo>0</portNo>
                <bannerEnabled>1</bannerEnabled>
            </LPD>
            <HPJetDirect>
                <name/>
                <enabled>1</enabled>
                <active>1</active>
                <Connections>
                    <connection>aa</connection>
                    <connection>aa</connection>
                </Connections>
                <Dependencies>
                    <protocol>aa</protocol>
                    <protocol>aa</protocol>
                </Dependencies>
                <Dependents>
                    <protocol>aa</protocol>
                    <protocol>aa</protocol>
                </Dependents>
                <portNo>0</portNo>
                <enabled>1</enabled>
            </HPJetDirect>
            <FTPPrint>
                <name>aa</name>
                <enabled>1</enabled>
                <active>1</active>
                <Dependencies>
                    <protocol>aa</protocol>
                    <protocol>aa</protocol>
                </Dependencies>
                <portNo>0</portNo>
                <loginName>String</loginName>
                <password>A9FD64E12C</password>
            </FTPPrint>
            <IPP>
                <name>aa</name>
                <enabled>1</enabled>
                <active>1</active>
                <Dependencies>
                    <protocol>aa</protocol>
                    <protocol>aa</protocol>
                </Dependencies>
                <portNo>0</portNo>
                <port80Enabled>1</port80Enabled>
            </IPP>
            <BONJOUR>
                <name>Bonjour</name>
                <ServiceName>testBonjour</ServiceName>
                <OperStatus>Enabled</OperStatus>
                <PortNumber>9100</PortNumber>
        <HostName>Bonjour_Linux@tabs.toshiba.com</HostName>
                <Dependencies>
                    <protocol>aa</protocol>
                    <protocol>aa</protocol>
                </Dependencies>
            </BONJOUR>
        </Services>
        <Protocols>
            <SMB>
                <name/>
                <enabled>1</enabled>
                <active>1</active>
                <Connections>
                    <connection>aa</connection>
                    <connection>aa</connection>
                </Connections>
                <Dependencies>
                    <protocol>aa</protocol>
                    <protocol>aa</protocol>
                </Dependencies>
                <Dependents>
                    <protocol>aa</protocol>
                    <protocol>aa</protocol>
                </Dependents>
                <deviceName>normalizedString</deviceName>
                <groupName>normalizedString</groupName>
                <wins>10.1.2.3</wins>
                <wins2>10.4.5.6</wins2>
                <scope>String</scope>
                <masterBrowser>1</masterBrowser>
                <printingEnabled>1</printingEnabled>
            </SMB>
            <IPX-SPX>
                <name/>
                <enabled>1</enabled>
                <active>1</active>
                <Connections>
                    <connection>aa</connection>
                    <connection>aa</connection>
                </Connections>
                <Dependencies>
                    <protocol>aa</protocol>
                    <protocol>aa</protocol>
                </Dependencies>
                <Dependents>
                    <protocol>aa</protocol>
                    <protocol>aa</protocol>
                </Dependents>
                <Adapter>
                    <enabled>1</enabled>
                    <frameType>AUTO</frameType>
                </Adapter>
            </IPX-SPX>
            <Appletalk>
                <enabled>1</enabled>
                <active>1</active>
                <Connections>
                    <connection>aa</connection>
                    <connection>aa</connection>
                </Connections>
                <Dependencies>
                    <protocol>aa</protocol>
                    <protocol>aa</protocol>
                </Dependencies>
                <Dependents>
                    <protocol>aa</protocol>
                    <protocol>aa</protocol>
                </Dependents>
                <zone>String</zone>
                <deviceName>String1</deviceName>
            </Appletalk>
            <TCP-IP>
                <name/>
                <enabled>1</enabled>
                <active>1</active>
                <Connections>
                    <connection>aa</connection>
                    <connection>aa</connection>
                </Connections>
                <Dependencies>
                    <protocol>aa</protocol>
                    <protocol>aa</protocol>
                </Dependencies>
                <Dependents>
                    <protocol>aa</protocol>
                    <protocol>aa</protocol>
                </Dependents>
                <dns>0x0x0x0</dns>
                <dns2>0x0x0x0</dns2>
                <AutoConfig>
                    <enabled>1</enabled>
                    <autoIPEnabled>0</autoIPEnabled>
                </AutoConfig>
                <ip>10.11.12.13</ip>
                <subnet>10.14.15.16.17</subnet>
                <gw>10.18.19.20.21</gw>
                <dnsEnabled>1</dnsEnabled>
                <ddnsEnabled>1</ddnsEnabled>
                <AddressMode>DHCP</AddressMode>
            </TCP-IP>
        </Protocols>
</Network>
```

Following the communication of the configuration file data 418 at step 626, flow proceeds to step 628, whereupon the operations of the commenced network services are tested by the network service manager 414. A determination is then made at step 630 whether the newly installed network service has been successfully started. When the service was unsuccessfully started, configuration file data 418 corresponding to a last known good configuration is retrieved from the associated data storage device 110 at step 632. Flow then proceeds to step 634, whereupon network services are then selectively restarted according to the retrieved configuration file data 418 by the network service manager 414 and flow returns to step 630. Upon a determination at step 632 that a service has been successfully initiated, normal operations of the document processing device 104 are commenced at step 636. A determination is then made at step 638 whether alteration data has been received from an administrator. That is, the document processing device 104 performs normal operations until an administrator, via a thin client interface, communicates alteration data to the document processing device 104. When no alteration data has been received, flow returns to step 636, whereupon normal operations of the document processing device 104 continue. Upon the receipt of alteration data, flow proceeds to step 640, whereupon the configuration file data 418 is modified to incorporate the changes received from the administrator. Network services are then selectively restarted at step 634 in accordance with the changes to the configuration file data 418 and upon successful restart, as determined at step 630, normal operations of the document processing device 104 are commenced shown at step 636.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A pluggable network stack interface system comprising:
a network interface stack including data representative of a mapping of a plurality of common network communication features associated with each of a plurality of networks stacks;
sensing means adapted for sensing a network stack associated with an installed network communication component;
registration means adapted for mapping features associated with a sensed network communication component in accordance with content of the network interface stack;
communication means adapted for commencing network services in accordance with an output of the registration means; and
means adapted for communicating configuration file data corresponding to commenced network services with an associated data storage.

2. The system of claim 1 further comprising:
testing means adapted for testing operation of commenced network services; and
means adapted for selectively restarting network services in accordance with configuration file data retrieved from the data storage in accordance with an output of the testing means.

3. The system of claim 2 wherein retrieved configuration file data is comprised of configuration file data associated with a last-known successfully commenced network services.

4. The system of claim 3 wherein the configuration file is comprised of an XML data file.

5. The system of claim 4 further comprising means adapted for altering the configuration file in accordance with an associated thin client interface.

6. The system of claim 1 further comprising means adapted for receiving mapping data associated with mapping of at least one predefined network stack, and wherein the registration means includes means adapted for registering a sensed communication component associated with the at least one predefined network stack corresponding thereto.

7. A method for generating a pluggable network stack interface comprising the steps of:
mapping, via a network interface stack, a plurality of common network communication features associated with each of a plurality of networks stacks;
sensing a network stack associated with an installed network communication component;
mapping features associated with a sensed network communication component in accordance with the mapping of the plurality of common network communication features;
commencing network services in accordance with an output of the step of mapping features associated with a sensed network communication component; and
communicating configuration file data corresponding to commenced network services with an associated data storage.

8. The method of claim 7 further comprising the step of:
testing operation of commenced network services; and
selectively restarting network services in accordance with configuration file data retrieved from the data storage in accordance with an output of the testing.

9. The method of claim 8 wherein retrieved configuration file data is comprised of configuration file data associated with a last-known successfully commenced network services.

10. The method of claim 9 wherein the configuration file is comprised of an XML data file.

11. The method of claim 10 further comprising the step of altering the configuration file in accordance with an associated thin client interface.

12. The method of claim 6 further comprising the steps of receiving mapping data associated with mapping of at least one predefined network stack, and registering a sensed communication component associated with the at least one predefined network stack corresponding thereto.

13. A computer-implemented method for generating a pluggable network stack interface comprising the steps of:
mapping, via a network interface stack, a plurality of common network communication features associated with each of a plurality of networks stacks;
sensing a network stack associated with an installed network communication component;
mapping features associated with a sensed network communication component in accordance with the mapping of the plurality of common network communication features;
commencing network services in accordance with an output of the step of mapping features associated with a sensed network communication component; and
communicating configuration file data corresponding to commenced network services with an associated data storage.

14. The computer-implemented method of claim 13 further comprising the step of:
testing operation of commenced network services; and
selectively restarting network services in accordance with configuration file data retrieved from the data storage in accordance with an output of the testing.

15. The computer-implemented method of claim 14 wherein retrieved configuration file data is comprised of configuration file data associated with a last-known successfully commenced network services.

16. The computer-implemented method of claim 15 wherein the configuration file is comprised of an XML data file.

17. The computer-implemented method of claim 16 further comprising the step of altering the configuration file in accordance with an associated thin client interface.

18. The computer-implemented method of claim 13 further comprising the steps of receiving mapping data associated with mapping of at least one predefined network stack, and registering a sensed communication component associated with the at least one predefined network stack corresponding thereto.
